(19) United States
(12) Patent Application Publication
(10) Pub. No.: US 2011/0085340 A1
(43) Pub. Date: Apr. 14, 2011

(54) LED recessed light with reflection board

(76) Inventors: Meng Hsieh Chou, Singjhuang City (TW); Yen Wei Pen, Singjhuang City (TW); You Chuen Lain, Singjhuang City (TW)

(21) Appl. No.: 12/703,764

(22) Filed: Feb. 11, 2010

(30) Foreign Application Priority Data
Oct. 9, 2009 (TW) 098218583

(51) Int. Cl. F21V 29/00

(52) U.S. Cl. 362/294

(57) ABSTRACT

An LED recessed light with reflection board includes a heat sink base, an LED illumination module mounted on the heat sink base, a sleeve, a reflection board and a transparent board. The sleeve having a fixed end, which is mounted on the heat sink base, an open end and a side wall, so that the LED illumination module is located within the sleeve. The reflection board is arranged at the side wall of the sleeve, then, the light from the LED illumination module may reflected by the reflection board. And the transparent board is located on the open end of the sleeve to cover the open end.

### FIELD OF THE INVENTION

The present invention relates to an LED recessed light with reflection board, and in particular to an LED recessed light capable of enhancing brightness of illumination.

### DESCRIPTION OF THE RELATED ART

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness.

As is generally known in the art, use has been made of varying kinds of illumination lamps for lightening or illuminating objects at night or indoors. Such illumination lamps are supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

### SUMMARY OF THE INVENTION

An object of the present invention is to provide an LED recessed light with reflection board capable of enhancing brightness of illumination.

To achieve the above-mentioned object, the present invention includes a heat sink base, an LED illumination module mounted on the heat sink base, a sleeve, a reflection board and a transparent board. The sleeve having a fixed end, which is mounted on the heat sink base, an open end and a side wall, so that the LED illumination module is located within the sleeve. The reflection board is arranged at the side wall of the sleeve, then, the light from the LED illumination module may reflected by the reflection board. And the transparent board is located on the open end of the sleeve to cover the open end.

### BRIEF DESCRIPTION OF THE DRAWINGS

FIG. 1 is an exploded view of an LED recessed light with transparent board of the present invention

FIG. 2 is a cross-sectional view of assembly drawing of the FIG. 1.

### DETAILED DESCRIPTION OF THE INVENTION

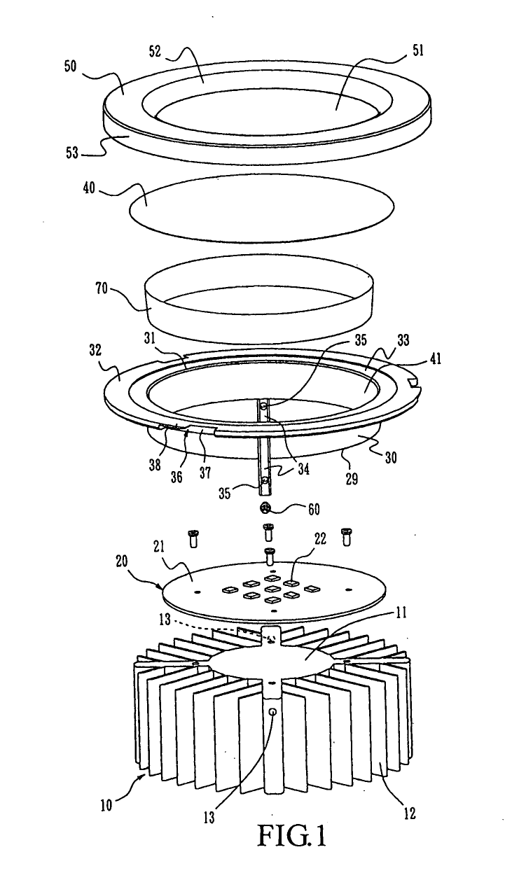

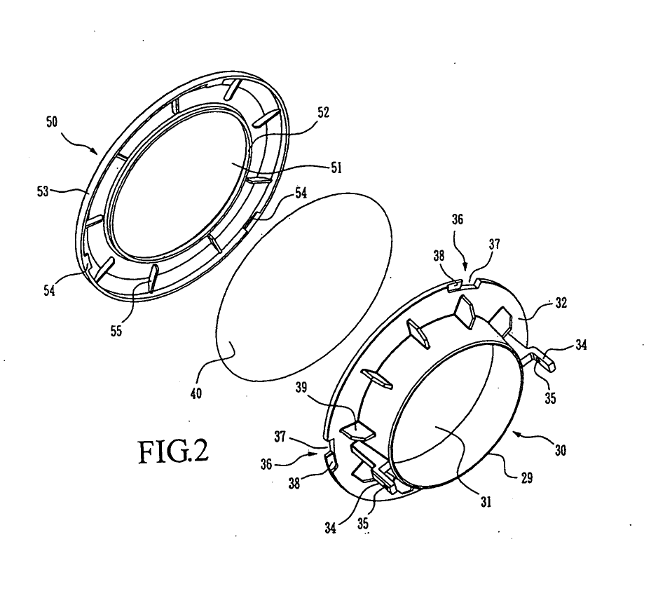

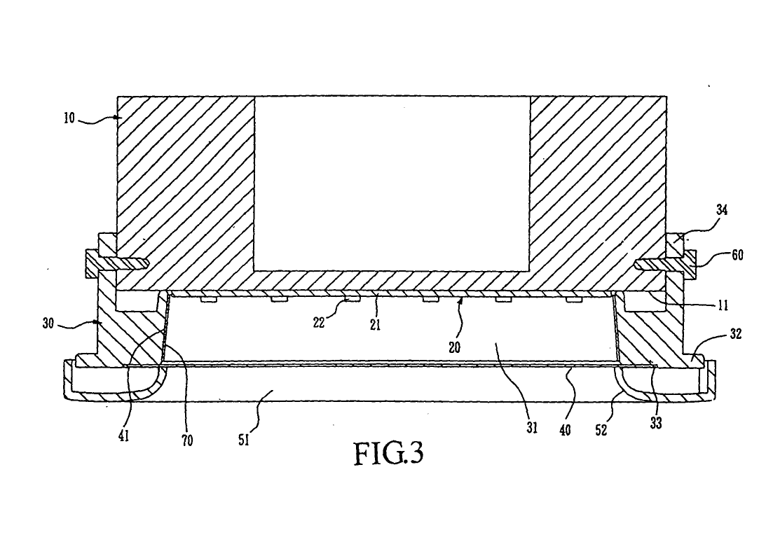

Referring to FIG. 1-FIG. 3, an LED recessed light with a reflection board of the present invention includes a heat sink base 10, an LED illumination module 20, a sleeve 30, a reflection board 70 and a decorating board 50. Wherein

The heat sink base 10, which is integrally having a surface 11, a plurality of heat sinks 12, and two first fixed holes 13 formed at the surface 11 of the heat sink base 10.

The LED illumination module 20, which includes a print circuit board 21 and a plurality of LED 22 are located on the print circuit board 22, wherein the print circuit board 22 is mounted on the surface 11 of the heat sink base 10.

The sleeve 30 has a fixed end 29 mounted on the heat sink base 10, an open end 31 and side wall 41, so as to the LED illumination module 20 is located within the sleeve 30 the open end 31 of the sleeve 30 extends outwardly formed with an external flange 32, which has a cavity 33, the fixed end 29 of the sleeve 30 extends outwardly formed with two positioning posts 34, which are formed with second fixed holes 35 corresponds to first fixed holes 13 of the heat sink base 10, so as to the positioning posts 34 may positioned on the heat sink base 10 by a fixed element 60 penetrated from the first fixed hole 13 and the second fixed hole 35. Another the external flange 32 of the sleeve 30 is formed with a blending portion 36, which has a recess 37, a stopping board 38 is located at the lateral side of the recess 37, a rib 39 is formed between the sleeve 30 and external flange 32 to enhance the strength of the sleeve 30.

The reflection board 70 is arranged at the side wall 41 of the sleeve 30.

The transparent board 40 is formed within the cavity 33 of the sleeve 30 for covering the open end 31 of the sleeve 30.

The decorating board 50, which is arranged on the open end 31 of the sleeve 30, a penetrated hole 51 is formed on the central of the decorating board 50, so that the transparent board 40 may exposed from the penetrated hole 51 of the decorating board 50.

Therefore, the light from the LED illumination module 20 may reflected through the reflection board 70 and shined through the transparent board 40 to enhance the brightness of illumination.

While the present has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modification.

What is claimed is:

1. An LED recessed light with reflection board comprising
A heat sink base;
An LED illumination module mounted on the heat sink base;
A sleeve having a fixed end, which is mounted on the heat sink base, an open end and a side wall, so that the LED illumination module is located within the sleeve;
A reflection board arranged at the side wall of the sleeve, then, the light from the LED illumination module may reflected by the reflection board; and
A transparent board located on the open end of the sleeve to cover the open end.

2. The LED recessed light with reflection board according to claim 1, further comprising a decorating board, which is arranged on the open end of the sleeve, a penetrated hole is formed on the decorating board, so that the transparent board may exposed from the penetrated hole of the decorating board.

3. The LED recessed light with reflection board according to claim 1, wherein the heat sink base has a plurality of heat sinks.

4. The LED recessed light with reflection board according to claim 1, wherein the LED illumination module includes a print circuit board, which is mounted on the heat sink base, and LED arranged on the print circuit board.

5. The LED recessed light with reflection board according to claim 1, wherein sleeve is formed with an external flange, which has a cavity, so that the transparent board is located within the cavity of the sleeve.

6. The LED recessed light with reflection board according to claim 1, wherein the sleeve includes two positioning posts to fix at the heat sink base.
